(19) United States
(12) Patent Application Publication
(10) Pub. No.: US 2025/0343315 A1
(43) Pub. Date: Nov. 6, 2025

(54) TRACTION BATTERY PACK COOLANT GUIDING BAFFLE

(71) Applicant: Ford Global Technologies, LLC, Dearborn, MI (US)

(72) Inventor: Brad Alan VanDerWege, Plymouth, MI (US)

(21) Appl. No.: 18/655,485

(22) Filed: May 6, 2024

(51) Int. Cl. H01M 50/291; B60L 50/64; B60L 58/26; H01M 10/613; H01M 10/625; H01M 10/6567; H01M 50/105; H01M 50/271

(52) U.S. Cl. CPC H01M 50/291; B60L 50/64; B60L 58/26; H01M 10/613; H01M 10/625; H01M 10/6567; H01M 50/105; H01M 50/271; H01M 2220/20

(57) ABSTRACT

A traction battery pack assembly includes an enclosure assembly; a first cell stack housed within the enclosure assembly; a second cell stack housed within the enclosure assembly; and a baffle housed within the enclosure assembly and positioned between the first and second cells stacks. The baffle includes a plurality of openings that permit flow of a coolant from a position adjacent the first cell stack to a position adjacent the second cell stack. The plurality of openings are within an vertical upper region of the baffle.

### TECHNICAL FIELD

This disclosure details exemplary systems that guide coolant within a battery pack and, more particularly, to a system that guides the coolant between cell stacks.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. As part of an immersion thermal management system, liquid coolant can be moved through the traction battery pack to help manage thermal energy within the traction battery pack.

### SUMMARY

In some aspects, the techniques described herein relate to a traction battery pack assembly, including: an enclosure assembly; a first cell stack housed within the enclosure assembly; a second cell stack housed within the enclosure assembly; and a baffle housed within the enclosure assembly and positioned between the first and second cells stacks, the baffle including a plurality of openings that permit flow of a coolant from a position adjacent the first cell stack to a position adjacent the second cell stack, the plurality of openings within an vertical upper region of the baffle.

In some aspects, the techniques described herein relate to a traction battery pack assembly, wherein the enclosure assembly includes a tray and a cover, wherein the plurality of openings each have a circumferential perimeter provided by the baffle and the cover.

In some aspects, the techniques described herein relate to a traction battery pack assembly, further wherein the plurality of openings each open to a vertically upper edge of the baffle.

In some aspects, the techniques described herein relate to a traction battery pack assembly, wherein the second cell stack includes a plurality of battery cell groups disposed along a cell stack axis, the battery cell groups separated from each other along the cell stack axis with dividers, the plurality of openings aligned with the dividers along the cell stack axis.

In some aspects, the techniques described herein relate to a traction battery pack assembly, wherein a circumferential perimeter of each of the openings within the plurality of openings is partially provided by the baffle and partially provided by a cover of the enclosure assembly.

In some aspects, the techniques described herein relate to a traction battery pack assembly, wherein the plurality of battery cells are pouch-style battery cells.

In some aspects, the techniques described herein relate to a traction battery pack assembly, wherein the coolant is a liquid coolant of an immersion cooling system.

In some aspects, the techniques described herein relate to a traction battery pack assembly, including: an enclosure assembly; a first cell stack housed within the enclosure assembly, the first cell stack including a plurality of first battery cell groups disposed along a first cell stack axis; a second cell stack housed within the enclosure assembly, the second cell stack including a plurality of second battery cell groups disposed along a second cell stack axis; and a baffle housed within the enclosure assembly and positioned between the first and second cells stacks, the baffle including a plurality of baffle openings that permit flow of a coolant from a position adjacent the first cell stack to a position that is adjacent more than one of the second battery cell groups within the second cell stack.

In some aspects, the techniques described herein relate to a traction battery pack assembly, wherein the first cell stack and the second cell stack are immersed in the coolant.

In some aspects, the techniques described herein relate to a traction battery pack assembly, further including a plurality of second dividers of the cell stack, the second dividers alternating with the second battery cell groups along the second cell stack axis, each of the baffle openings within the plurality of baffle openings aligned with one of the second dividers along the second cell stack axis.

In some aspects, the techniques described herein relate to a traction battery pack assembly, wherein the plurality of openings are within an vertical upper region of the baffle.

In some aspects, the techniques described herein relate to a traction battery pack assembly, wherein a circumferential perimeter of each of the openings within the plurality of openings is partially provided by the baffle and partially provided by a cover of the enclosure assembly.

In some aspects, the techniques described herein relate to a traction battery pack assembly, wherein the coolant is a liquid coolant of an immersion cooling system.

In some aspects, the techniques described herein relate to a method of managing thermal energy levels within a traction battery pack, including: guiding a coolant through an enclosure assembly that houses a first cell stack and a second cell stack; and within the enclosure, guiding the coolant through an opening in a baffle that is disposed between the first cell stack and the second cell stack, the opening aligned with a divider of the second cell stack such that coolant that has passed over the first cell stack is directed toward the divider of the second cell stack, the divider disposed between groups of battery cells within the second cell stack.

In some aspects, the techniques described herein relate to a method, wherein the opening is one of a plurality of openings in the baffle, wherein the divider is one of a plurality of dividers in the second cell stack, the method including aligning each of the openings in the plurality of openings with one of the dividers in the plurality of dividers.

In some aspects, the techniques described herein relate to a method, wherein all the coolant that is guided through the enclosure assembly passes through one of the openings in the plurality of openings.

In some aspects, the techniques described herein relate to a method, wherein the opening is in a vertical upper region of the baffle.

In some aspects, the techniques described herein relate to a method, wherein the opening opens to a vertical upper edge of the baffle.

In some aspects, the techniques described herein relate to a method, wherein the coolant is a liquid coolant of an immersion cooling system.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a perspective view of the battery pack of FIG. 1 along with portions of an immersion thermal management system.

FIG. 3 illustrates an expanded view of the battery pack of FIG. 2.

FIG. 4 illustrates a top view of the battery pack of FIG. 2 with a cover removed.

FIG. 5 illustrates a section view taken at line 5-5 in FIG. 2.

### DETAILED DESCRIPTION

An immersion thermal management system can be used to manage thermal energy in a traction battery pack by immersing at least some components in a liquid coolant. The immersed components can include cell stacks that are housed within an enclosure. This disclosure is directed toward guiding the liquid coolant within the enclosure.

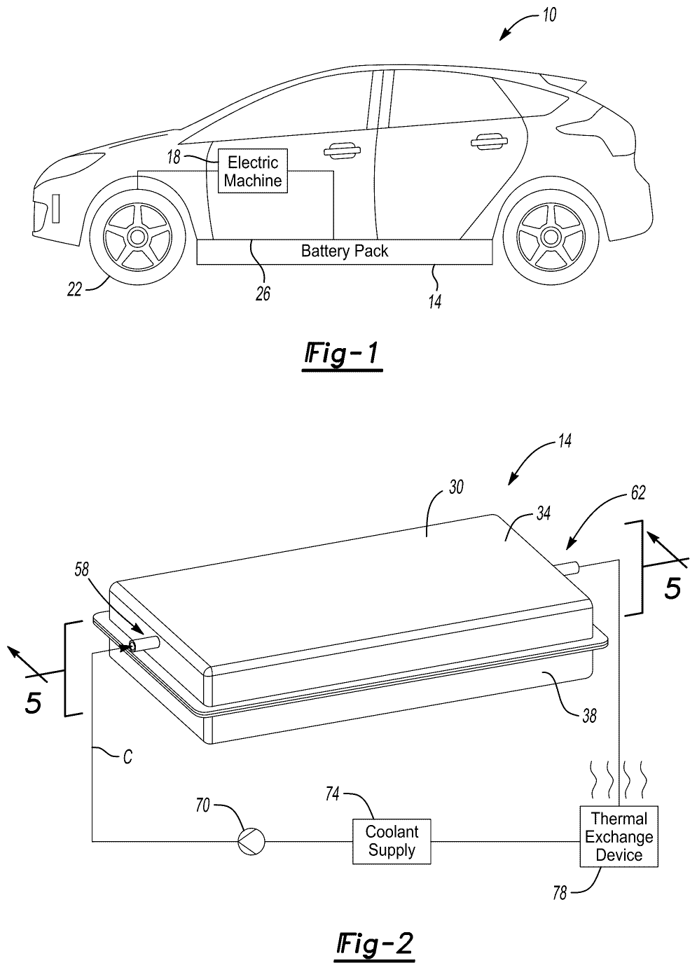

With reference to FIG. 1, an electrified vehicle 10 includes a traction battery pack 14, an electric machine 18, and wheels 22. The traction battery pack 14 powers an electric machine 18, which can convert electrical power to mechanical power to drive the wheels 22. The traction battery pack 14 can be a relatively high-voltage battery.

The traction battery pack 14 is, in the exemplary embodiment, secured to an underbody 26 of the electrified vehicle 10. The traction battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

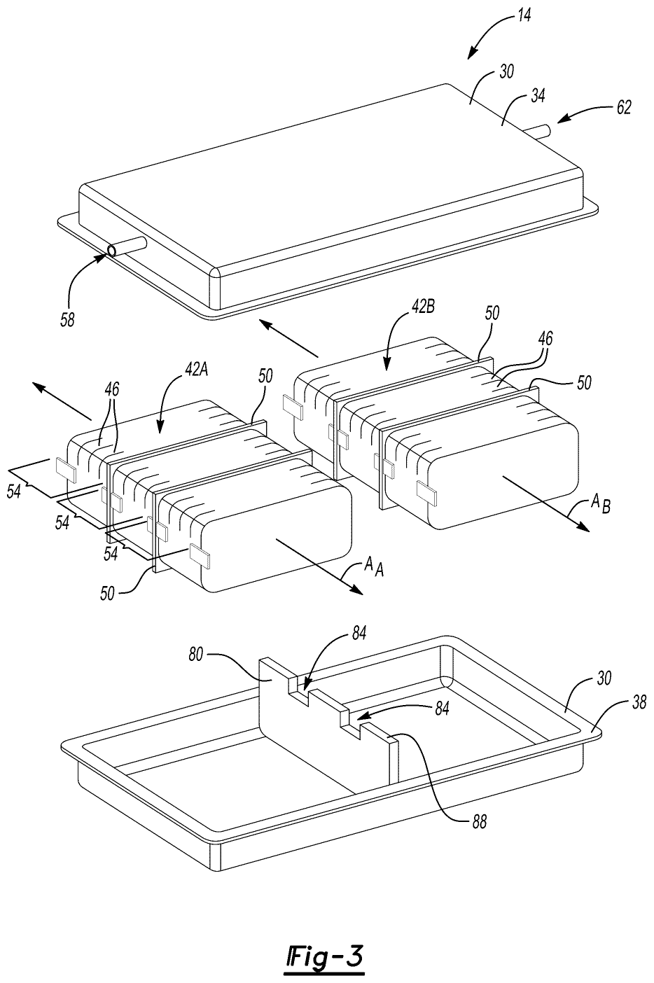

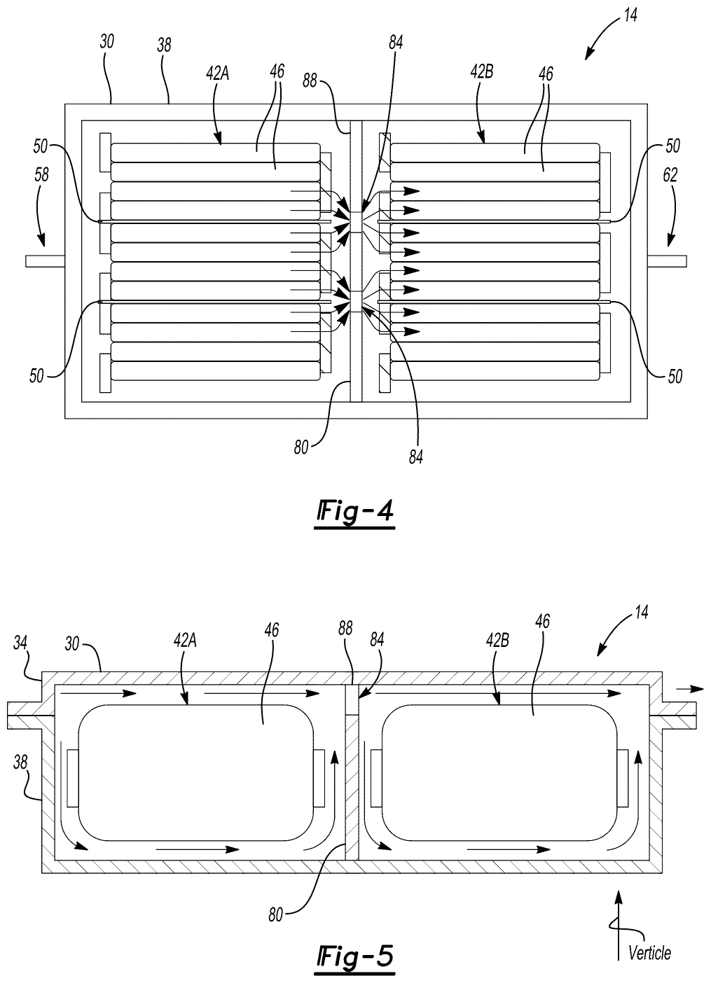

FIGS. 2 to 5 illustrate additional detail of the example battery pack 14. In this example, the battery pack 14 includes an enclosure assembly 30. The enclosure assembly 30 includes a cover 34 and a tray 38. The cover 34, in this example, is vertically above the tray 38. In other examples, however, the cover 34 could be arranged below, or to a side of the tray 38.

Various terms such as “above,” “below,” “top,” and “bottom” are used relative to the arrangement of the components of the battery pack 14 in the various drawings and should not otherwise be deemed limiting. These terms are with reference to the general orientation of the battery pack 14 when installed within the vehicle 10 of FIG. 1,

The cover 34 is welded to the tray 38 in one example of this disclosure. While welding is mentioned, the cover 34 and tray 38 could be connected using other fluid-tight connection techniques, such as adhesive. Further, while an exemplary enclosure assembly 30 is shown in the drawings, the enclosure assembly 30 may vary in size, shape, and configuration within the scope of this disclosure.

In the example embodiment, a plurality of cell stacks 42A, 42B are housed within the enclosure assembly 30. The cells stacks 42A, 42B each include a plurality of individual battery cells 46 and dividers 50 disposed along a respective cell stack axis A_{A}, A_{B}. The battery cells 46 can be lithium-ion pouch-style cells. However, battery cells having other geometries (cylindrical, etc.), other chemistries (nickel-metal hydride, lead-acid, etc.), or both could alternatively be utilized within the scope of this disclosure.

The battery cells 46 are arranged in groups 54 along the respective cell stack axis A_{A}, A_{B}. The dividers 50 separate the groups 54 of battery cells 46 from each other along the respective cell stack axis A_{A}, A_{B}. In this example, the groups 54 each include four individual battery cells 46. Other numbers of battery cells 46 could be included in the groups 54 in other examples. In some examples, each group 54 could include a single battery cell 46. There are three groups 54 in the cell stack 42A and three groups 54 in the cell stack 42B, but other numbers of groups 54 could be used.

The cell stacks 42A, 42B are housed in an interior of the enclosure assembly 30 between the tray 38 and beneath the cover 34. A thermal management system is used to manage thermal energy levels within the battery pack 14, including thermal energy levels of the cell stacks 42A, 42B.

The example thermal management system is an immersion cooling system that circulates a liquid coolant C into the interior of the enclosure assembly 30 to manage thermal energy levels within the cell stacks 42A, 42B and elsewhere within the battery pack 14. The cell stacks 42A, 42B are at least partially immersed in the liquid coolant C. The liquid coolant C can be a non-conductive (i.e., dielectric) liquid coolant C. The thermal management system is considered an immersion thermal management system at least because portions of the battery pack 14, here at least the battery cells 46 of the cell stacks 42A, 42B are immersed in the coolant C.

In this example, the coolant C flows to the interior through an inlet port 58, which is formed in the cover 34. The coolant C exits the interior of the enclosure through an outlet port 62, which is formed in the cover 34 at an opposite end of the enclosure assembly 30 from the inlet port 58.

The thermal management system incorporates a pump 70, a coolant supply 74, and a thermal exchange device 78. The pump 70 can be activated to circulate the coolant C along a coolant loop passing through the enclosure assembly 30, thermal exchange device 78, the coolant supply 74, and the pump 70. When passing through the enclosure assembly 30, the coolant C can take on thermal energy from components of the battery pack 14 including, but not limited to, the cell stacks 42A, 42B.

A baffle 80 is housed within the enclosure assembly 30. The baffle 80 is positioned between the cell stacks 42A, 42B within the interior of the enclosure assembly 30. The baffle 80 includes a plurality of openings 84 that permit flow of the coolant C from a position adjacent the cell stacks 42A to a position adjacent the other cell stack 42B. The baffle 80 can be secured directly to the tray 38. In some examples, the baffle 80 can be formed together with the tray 38.

In this example, the openings 84 are within a vertically upper region of the baffle 80. In particular, the openings 84 each open to a vertically upper edge 88 of the baffle 80 in this example. A circumferential perimeter of each of the openings 84 is provided by the baffle 80 and the cover 34.

Vertical, for purposes of this disclosure, is with reference to ground and a general orientation of the battery pack 14 when installed within the vehicle 10.

Each of the openings 84 is, in this example, aligned with one of the dividers 50 in the cell stacks 42B. The openings 84 can be considered to be aligned with the dividers 50 along the cell stack axis A_{B}.

Coolant C that has moved into the interior of the enclosure assembly 30 from the inlet port 58 first moves over the cell stack 42A and takes on thermal energy from the cell stack 42A—and sometimes energy associated with a thermal event where one or more of the battery cells 46 in the cell stack 42A is venting into the coolant C. After moving over the cell stack 42A, the coolant C then moves through one of the openings 84. Because the openings 84 are aligned with the dividers 50 in the cell stack 42B, flow that moves through the openings 84 is directed toward the dividers 50 within the cell stacks 42B.

Thermal energy that the coolant C has taken on from the cell stack 42A is at least initially directed to the divider 50 in the cell stack 42B and to more than one of the groups 54 within the cell stack 42B. This can help distribute the thermal energy within the liquid coolant C to more than one of the groups 54 of battery cells 46 within the cell stack 42B. Directing thermal energy within the liquid coolant C to more than one of the groups 54 can help to inhibit thermal energy building up in one of the groups 54 and leading to a cascading thermal event.

As the openings 84 are within a vertical upper region of the baffle 80, any gaseous vent byproducts released from the cell stack 42A, which rise to the top of the enclosure assembly 30, are directed through the openings 84 and then to the outlet port 62 from the enclosure assembly 30. As the gaseous vent byproducts tend to rise within the coolant C to a vertically upper region of the interior of the enclosure assembly 30, positioning the openings 84 in the upper region of the baffle 80 can facilitate communicating the gaseous vent byproducts from the interior of the enclosure assembly 30.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
an enclosure assembly;
a first cell stack housed within the enclosure assembly;
a second cell stack housed within the enclosure assembly; and
a baffle housed within the enclosure assembly and positioned between the first and second cells stacks, the baffle including a plurality of openings that permit flow of a coolant from a position adjacent the first cell stack to a position adjacent the second cell stack, the plurality of openings within an vertical upper region of the baffle.

2. The traction battery pack assembly of claim 1, wherein the enclosure assembly includes a tray and a cover, wherein the plurality of openings each have a circumferential perimeter provided by the baffle and the cover.

3. The traction battery pack assembly of claim 1, further wherein the plurality of openings each open to a vertically upper edge of the baffle.

4. The traction battery pack assembly of claim 1, wherein the second cell stack includes a plurality of battery cell groups disposed along a cell stack axis, the battery cell groups separated from each other along the cell stack axis with dividers, the plurality of openings aligned with the dividers along the cell stack axis.

5. The traction battery pack assembly of claim 1, wherein a circumferential perimeter of each of the openings within the plurality of openings is partially provided by the baffle and partially provided by a cover of the enclosure assembly.

6. The traction battery pack assembly of claim 1, wherein the plurality of battery cells are pouch-style battery cells.

7. The traction battery pack assembly of claim 1, wherein the coolant is a liquid coolant of an immersion cooling system.

8. A traction battery pack assembly, comprising:
an enclosure assembly;
a first cell stack housed within the enclosure assembly, the first cell stack including a plurality of first battery cell groups disposed along a first cell stack axis;
a second cell stack housed within the enclosure assembly, the second cell stack including a plurality of second battery cell groups disposed along a second cell stack axis; and
a baffle housed within the enclosure assembly and positioned between the first and second cells stacks, the baffle including a plurality of baffle openings that permit flow of a coolant from a position adjacent the first cell stack to a position that is adjacent more than one of the second battery cell groups within the second cell stack.

9. The traction battery pack assembly of claim 8, wherein the first cell stack and the second cell stack are immersed in the coolant.

10. The traction battery pack assembly of claim 8, further comprising a plurality of second dividers of the cell stack, the second dividers alternating with the second battery cell groups along the second cell stack axis, each of the baffle openings within the plurality of baffle openings aligned with one of the second dividers along the second cell stack axis.

11. The traction battery pack assembly of claim 8, wherein the plurality of openings are within an vertical upper region of the baffle.

12. The traction battery pack assembly of claim 8, wherein a circumferential perimeter of each of the openings within the plurality of openings is partially provided by the baffle and partially provided by a cover of the enclosure assembly.

13. The traction battery pack assembly of claim 8, wherein the coolant is a liquid coolant of an immersion cooling system.

14. A method of managing thermal energy levels within a traction battery pack, comprising:
guiding a coolant through an enclosure assembly that houses a first cell stack and a second cell stack; and
within the enclosure, guiding the coolant through an opening in a baffle that is disposed between the first cell stack and the second cell stack, the opening aligned with a divider of the second cell stack such that coolant that has passed over the first cell stack is directed toward the divider of the second cell stack, the divider disposed between groups of battery cells within the second cell stack.

15. The method of claim 14, wherein the opening is one of a plurality of openings in the baffle, wherein the divider is one of a plurality of dividers in the second cell stack, the method comprising aligning each of the openings in the plurality of openings with one of the dividers in the plurality of dividers.

16. The method of claim 15, wherein all the coolant that is guided through the enclosure assembly passes through one of the openings in the plurality of openings.

17. The method of claim 14, wherein the opening is in a vertical upper region of the baffle.

18. The method of claim 14, wherein the opening opens to a vertical upper edge of the baffle.

19. The method of claim 14, wherein the coolant is a liquid coolant of an immersion cooling system.
